(19) United States
(12) Patent Application Publication
(10) Pub. No.: US 2021/0031305 A1
(43) Pub. Date: Feb. 4, 2021

(54) LASER PROCESSING MACHINE, CONTROL APPARATUS, AND DETERMINATION METHOD

(71) Applicant: Mitsubishi Electric Corporation, Tokyo (JP)

(72) Inventors: Motoaki NISHIWAKI, Tokyo (JP); Toshiki KOSHIMAE, Tokyo (JP); Hiroyoshi OMURA, Tokyo (JP); Takahiro KOZUKI, Tokyo (JP)

(73) Assignee: Mitsubishi Electric Corporation, Tokyo (JP)

(21) Appl. No.: 17/043,676

(22) PCT Filed: May 7, 2018
(86) PCT No.: PCT/JP2018/017660

§ 371 Date: Sep. 30, 2020

(51) Int. Cl. B23K 26/382; B23K 26/03; G05B 19/4155

(52) U.S. Cl. CPC B23K 26/382; G05B 2219/45165; G05B 19/4155; B23K 26/032

(57) ABSTRACT

A laser processing machine includes a laser oscillator that emits a laser beam, a processing head that laser processes a workpiece by performing irradiation with the laser beam, a control apparatus that controls the laser oscillator and the processing head, an optical sensor that measures scattered light from the workpiece, the scattered light being generated when the workpiece is irradiated with the laser beam, and outputs a signal corresponding to the scattered light, a threshold setting unit that, on the basis of the signal output during a certain period after a piercing process is started, sets a threshold serving as a criterion for determining whether a hole has penetrated the workpiece by the piercing process, and a penetration determination unit that determines whether a hole has penetrated the workpiece on the basis of the signal and the threshold.

### FIELD

The present invention relates to a laser processing machine, a control apparatus, and a determination method for detecting penetration by a piercing process.

### BACKGROUND

A laser processing machine which performs a cutting process on an object to be worked performs a piercing process on the object to be worked and then performs the cutting process on the object to be worked. In the laser processing machine, a processing time can be shortened by starting the cutting process of the object to be worked immediately after accurately detecting timing when a hole penetrates the object to be worked by the piercing process.

As one of methods for determining timing when a hole penetrates an object to be worked, there is a method in which light scattered from an object to be worked is detected during laser processing, and whether a hole has penetrated the object to be worked is determined on the basis of the light intensity of the scattered light.

A laser processing device described in Patent Literature 1 measures a waveform for comparison in advance of the start of a piercing process, compares the waveform for comparison with a waveform of scattered light detected during an actual process, and determines the quality of the process on the basis of a result of the comparison.

### CITATION LIST

### Patent Literature

Patent Literature 1: Japanese Patent Application Laid-open No. 2010-094693

### SUMMARY

### Technical Problem

In the technique of Patent Literature 1 described above, since the waveform for comparison measured in advance is used as a threshold during the piercing process, there is no problem at the beginning of the process. However, in the technique of Patent Literature 1 described above, when the intensity of reflected light from the object to be worked which affects the actual waveform changes as a result of contamination of a processing nozzle caused by change with time or the like, the waveform actually obtained as a result of contamination of the processing nozzle or the like deviates from the waveform for comparison initially used. Consequently, there occurs a difference between an initially set threshold and a threshold to be actually used, and it may not be possible to accurately determine whether a hole has penetrated the object to be worked.

The present invention has been made in view of the above, and an object thereof is to obtain a laser processing machine capable of accurately determining whether a hole has penetrated an object to be worked even if there is change with time.

### Solution to Problem

In order to solve the above-described problem and achieve the object, a laser processing machine of the present invention includes a laser oscillator unit that emits a laser beam, a processing head unit that laser processes an object to be worked by performing irradiation with the laser beam, a processing machine control unit that controls the laser oscillator unit and the processing head unit, and a light measurement unit that measures scattered light from the object to be worked, the scattered light being generated when the object to be worked is irradiated with the laser beam, and outputs a signal corresponding to the scattered light. The laser processing machine of the present invention further includes a threshold setting unit that, on the basis of the signal output during a certain period after a piercing process is started, sets a threshold serving as a criterion for determining whether a hole has penetrated the object to be worked by the piercing process, and a penetration determination unit that determines whether a hole has penetrated the object to be worked on the basis of the signal and the threshold.

### Advantageous Effects of Invention

The laser processing machine according to the present invention achieves an effect that it is possible to accurately determine whether a hole has penetrated an object to be worked even if there is change with time.

### BRIEF DESCRIPTION OF DRAWINGS

FIG. 1 is a diagram illustrating a configuration of a laser processing machine according to a first embodiment of the present invention.

FIG. 2 is a diagram illustrating a configuration of a processing head included in the laser processing machine according to the first embodiment.

FIG. 3 is a diagram for explaining scattering of a laser beam before a hole penetrates a workpiece.

FIG. 4 is a diagram for explaining scattering of the laser beam after the hole penetrates the workpiece.

FIG. 5 is a block diagram illustrating a configuration of a control apparatus included in the laser processing machine according to the first embodiment.

FIG. 6 is a flowchart illustrating a processing procedure of a piercing process performed by the laser processing machine according to the first embodiment.

FIG. 7 is a diagram for explaining a penetration determination process performed by the laser processing machine according to the first embodiment.

FIG. 8 is a diagram for explaining another example of the penetration determination process performed by the laser processing machine according to the first embodiment.

FIG. 9 is a flowchart illustrating another example of an output voltage acquisition processing procedure performed by the laser processing machine of the first embodiment.

FIG. 10 is a flowchart illustrating another example of a processing procedure of penetration determination performed by the laser processing machine of the first embodiment.

FIG. 11 is a diagram for explaining a penetration determination process performed by the laser processing machine according to a second embodiment.

FIG. 12 is a diagram for explaining timing of penetration determined by a penetration determination method of the second embodiment.

### DESCRIPTION OF EMBODIMENTS

Hereinafter, a laser processing machine, a control apparatus, and a determination method according to each embodiment of the present invention will be described in detail with reference to the drawings. The invention is not limited to the embodiments.

### First Embodiment

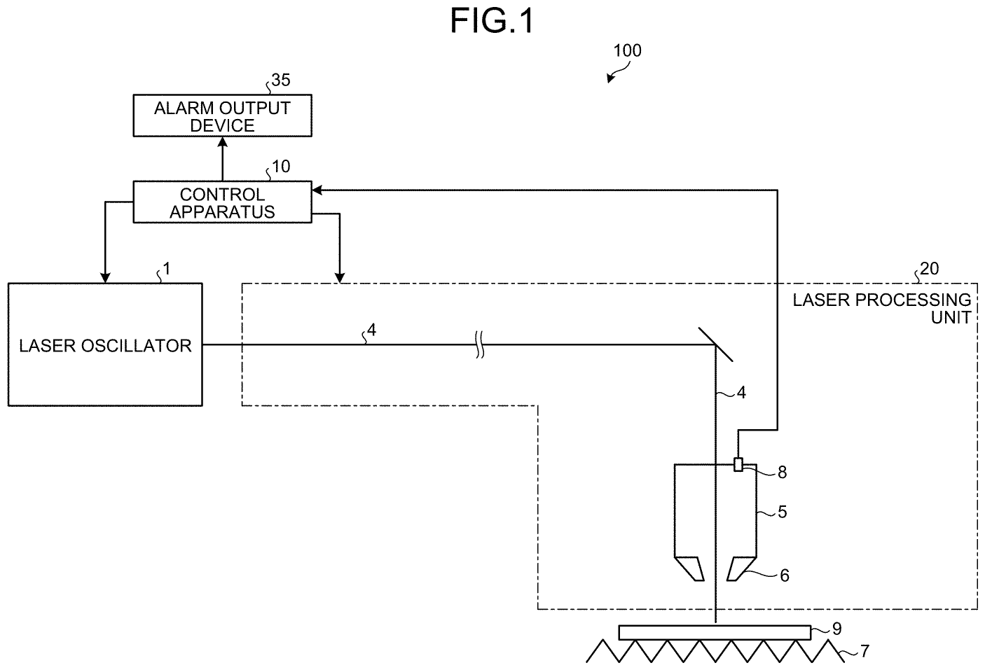

FIG. 1 is a diagram illustrating a configuration of a laser processing machine according to a first embodiment of the present invention. A laser processing machine 100 sets a threshold which serves as a criterion for determining whether a hole has penetrated a workpiece 9 during one hole drilling process which is one operation of a piercing process, and determines whether the hole has penetrated the workpiece 9 on the basis of the threshold.

The laser processing machine 100 includes a laser oscillator 1 which is a laser oscillator unit which emits a laser beam 4, a laser processing unit 20 which laser processes the workpiece 9 in a plate shape by irradiation with the laser beam 4, the workpiece 9 being an object to be worked, a control apparatus 10 which controls the laser oscillator 1 and the laser processing unit 20, and an alarm output device 35 which is an alarm output unit.

The laser processing unit 20 includes a processing head 5 which is a processing head unit, and a nozzle 6 is provided at a tip of the processing head 5. The workpiece 9 is placed on a processing table 7. The workpiece 9 is irradiated with, from the nozzle 6, the laser beam 4 from the laser oscillator 1.

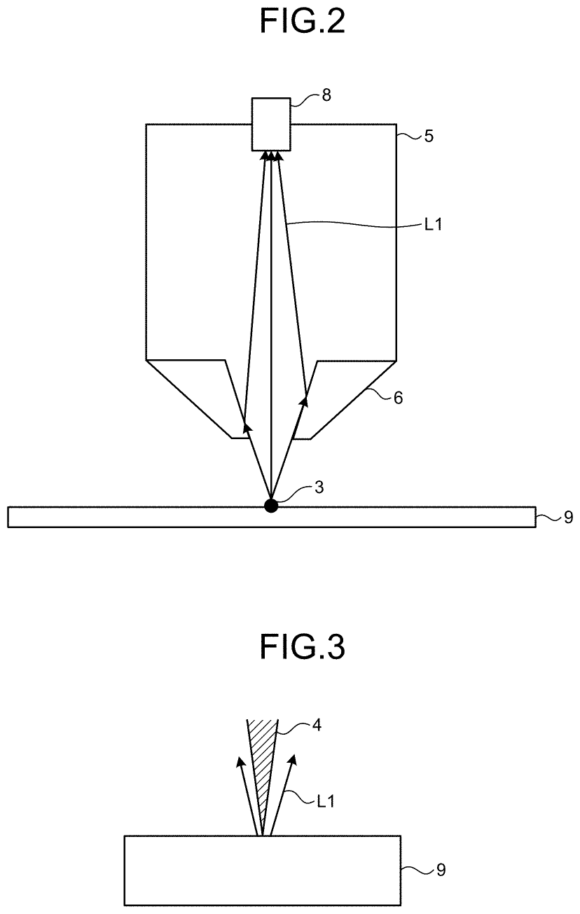

FIG. 2 is a diagram illustrating a configuration of the processing head included in the laser processing machine according to the first embodiment. An optical sensor 8 is provided to the processing head 5. The optical sensor 8 is arranged at a position where the laser beam 4 does not pass. The optical sensor 8 includes a photodiode, and uses the photodiode to detect light scattered by the workpiece 9 or the like during laser processing.

When the laser beam 4 is emitted from the nozzle 6 of the processing head 5, an irradiation position 3 of the workpiece 9 is irradiated with the laser beam 4. The optical sensor 8, which is an example of a light measurement unit, receives scattered light L1 scattered at the irradiation position 3 during the laser processing, and outputs a voltage depending on the amount of the scattered light L1 thus received. The output voltage from the optical sensor 8 is sent to the control apparatus 10. The optical sensor 8 may send a signal other than the voltage to the control apparatus 10 as long as it is a signal depending on the amount of light.

The control apparatus 10 is a computer which controls the processing head 5 and the like included in the laser processing unit 20. The control apparatus 10 determines whether a hole has penetrated the workpiece 9 at the irradiation position 3 on the basis of a change in the output voltage taken in during the piercing process. The timing when the hole penetrates the workpiece 9 is a piercing process end timing. In the following description, the determination of whether a hole has penetrated the workpiece 9 may be referred to as penetration determination. In addition, the control apparatus 10 determines an abnormality in the piercing process on the basis of the output voltage taken in during the piercing process, and if there is an abnormality, the control apparatus 10 causes the alarm output device 35 to output an alarm. The alarm output device 35 is a device which outputs an alarm in accordance with an instruction from the control apparatus 10.

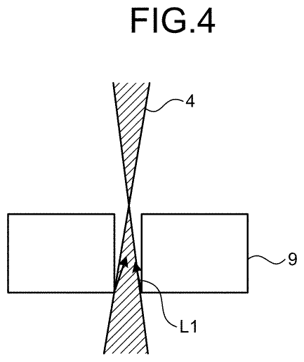

FIG. 3 is a diagram for explaining scattering of the laser beam before a hole penetrates the workpiece, and FIG. 4 is a diagram for explaining the scattering of the laser beam after the hole penetrates the workpiece. As illustrated in FIG. 3, the laser beam 4 is reflected from the workpiece 9 before the hole penetrates the workpiece 9, so that the scattered light L1 is generated in a large amount. On the other hand, as illustrated in FIG. 4, after the hole penetrates the workpiece 9, the laser beam 4 is sent to a back surface side of the workpiece 9 through a pierced hole which is a through hole, so that the scattered light L1 is generated in a smaller amount.

As described above, during the piercing process, the laser beam 4 becomes no longer reflected from the workpiece 9 due to the pierced hole penetrating the workpiece 9, so that the amount of light detected by the optical sensor 8 decreases. This means that the output voltage from the optical sensor 8 decreases. The laser processing machine 100 of the present embodiment utilizes the decrease in the output voltage to determine that the penetration has been completed when the output voltage from the optical sensor 8 becomes equal to or lower than the threshold.

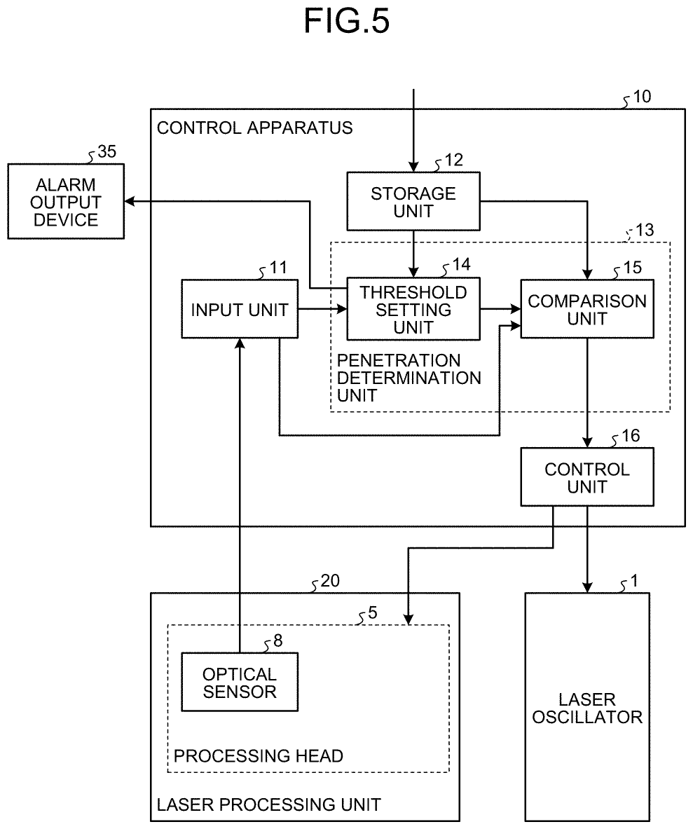

FIG. 5 is a block diagram illustrating a configuration of the control apparatus included in the laser processing machine according to the first embodiment. The control apparatus 10 includes an input unit 11, a storage unit 12, a penetration determination unit 13, and a control unit 16 which is a processing machine control unit.

The input unit 11 receives the output voltage from the optical sensor 8 and inputs the output voltage to the penetration determination unit 13. The storage unit 12 stores timing when the penetration determination unit 13 acquires the output voltage. The timing when the penetration determination unit 13 acquires the output voltage is timing when acquiring the output voltage from the optical sensor 8 in order to set the threshold used for the penetration determination, and timing when acquiring the output voltage for comparison with the threshold at the penetration determination. The storage unit 12 stores an acquisition start timing to start the acquisition of the output voltage in order to set the threshold, an acquisition end timing to end the acquisition of the output voltage for setting the threshold, and a penetration determination timing to start the penetration determination. As a period from the acquisition start timing to the acquisition end timing, a period is set in which the output voltage is stable after a piercing process is started, and the penetration by the hole is still no closer to completion thereof. The threshold used for the penetration determination is a threshold of the output voltage, and it is determined that the hole has penetrated the workpiece 9 when the output voltage becomes equal to or lower than the threshold.

The penetration determination unit 13 includes a threshold setting unit 14 and a comparison unit 15. The threshold setting unit 14 acquires the output voltage output from the optical sensor 8 over a plurality of times during a period from the acquisition start timing to the acquisition end timing, performs an averaging process on the acquired output voltages, and sets a threshold of the output voltage on the basis of a voltage value obtained through the averaging process. The period in which the averaging process is performed is a period in which the output voltage is stable and the penetration by the hole is still no closer to completion thereof, and consequently, if the output voltage decreases below the output voltage during the above period by a specific proportion, it is possible to determine that the hole has penetrated the workpiece 9. Therefore, the threshold setting unit 14 sets a value smaller than the voltage value obtained through the averaging process by a specific proportion as the threshold of the output voltage. For example, the threshold setting unit 14 sets a value which is 10% smaller than an average value of the voltage value obtained through the averaging process as the threshold of the output voltage. The threshold setting unit 14 may set a value smaller than the average value of the voltage value obtained through the averaging process by a specific value as the threshold of the output voltage. The threshold setting unit 14 sends the set threshold to the comparison unit 15. As described above, the threshold setting unit 14 sets a threshold which serves as a criterion for determining whether a hole has penetrated the workpiece 9 by the piercing process, on the basis of the output voltage output during a certain period after the piercing process is started. In addition, the threshold setting unit 14 determines that the piercing process is abnormal when the voltage value obtained through the averaging process falls outside a reference range and a set time elapses, and causes the alarm output device 35 to output an alarm.

The comparison unit 15 starts the acquisition of the output voltage from the optical sensor 8 at the penetration determination timing, and compares the acquired output voltage with the threshold set by the threshold setting unit 14. The comparison unit 15 determines that the hole has penetrated the workpiece 9 when the output voltage acquired after the penetration determination timing is equal to or lower than the threshold and the set time elapses. When the comparison unit 15 determines that the hole has penetrated the workpiece 9, the comparison unit 15 sends a penetration notification indicating that the penetration has been achieved to the control unit 16. The control unit 16 is connected to the processing head 5 and the laser oscillator 1, and when receiving the penetration notification from the comparison unit 15, the control unit 16 controls the processing head 5 and the laser oscillator 1 to perform the cutting process.

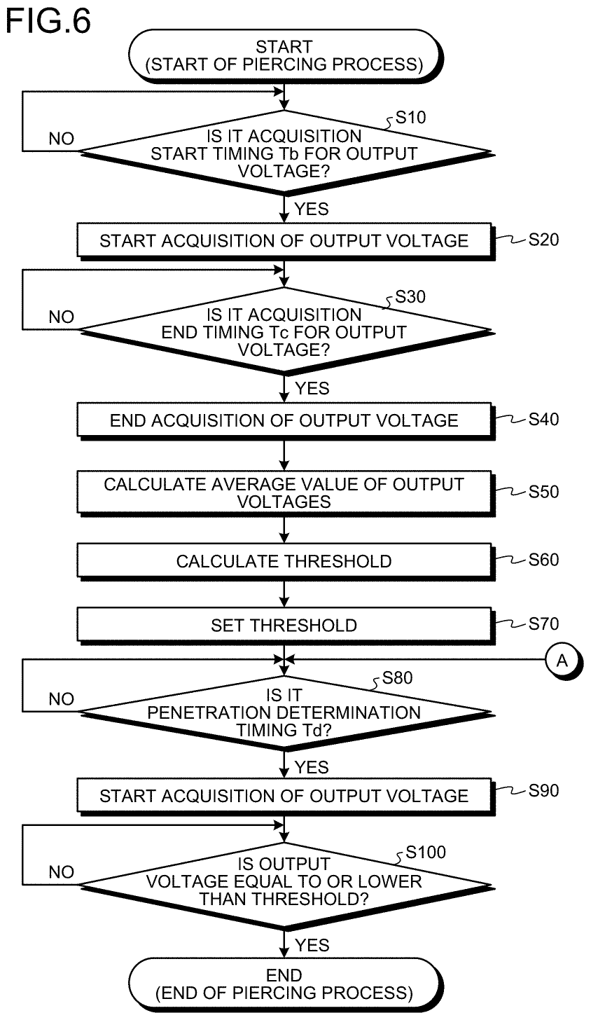

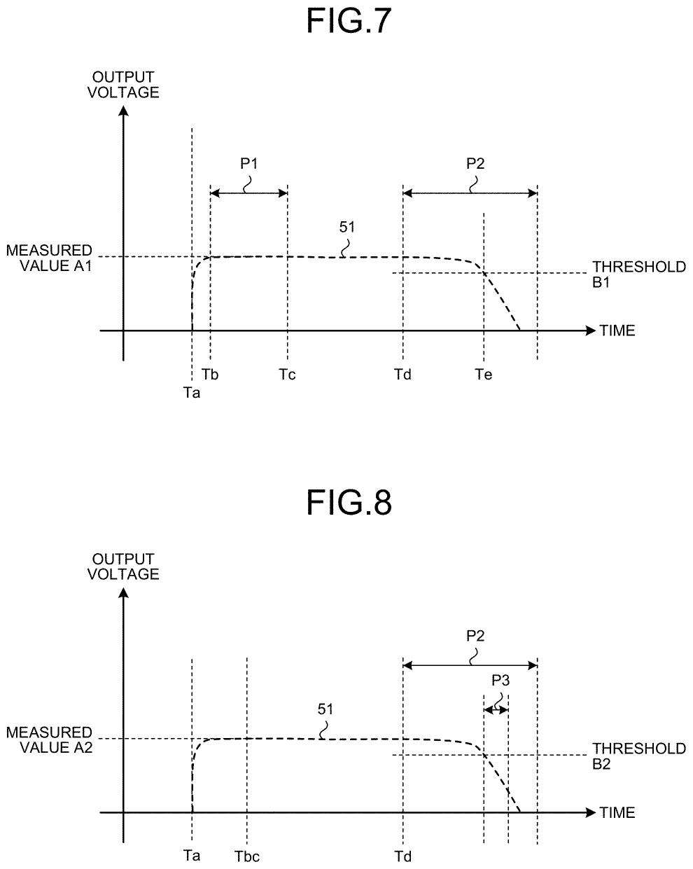

FIG. 6 is a flowchart illustrating a processing procedure of a piercing process performed by the laser processing machine according to the first embodiment. FIG. 7 is a diagram for explaining a penetration determination process performed by the laser processing machine according to the first embodiment. The processing procedure illustrated in FIG. 6 is a processing procedure when performing one operation of the piercing process (one hole drilling process). In FIG. 7, a waveform 51 of the output voltage from the optical sensor 8 is illustrated. The horizontal axis in FIG. 7 is time, and the vertical axis therein is the output voltage from the optical sensor 8. In FIG. 7, timing when the laser processing machine 100 starts the piercing process is indicated by a piercing start timing Ta, timing when starting the acquisition of the output voltage for setting the threshold is indicated by an acquisition start timing Tb, and timing when ending the acquisition of the output voltage for setting the threshold is indicated by an acquisition end timing Tc. In addition, in FIG. 7, a penetration determination timing when starting the penetration determination is indicated by a penetration determination timing Td, and timing when the hole penetrates the workpiece 9 is indicated by a penetration timing Te.

At the piercing start timing Ta when starting one operation of the piercing process, the laser processing machine 100 starts the piercing process on the workpiece 9. During the piercing process, the optical sensor 8 continues to send the output voltage corresponding to the scattered light L1 from the workpiece 9 to the control apparatus 10.

The threshold setting unit 14 determines whether it is the acquisition start timing Tb for the output voltage (step S10). If it is not the acquisition start timing Tb for the output voltage (step S10, No), the threshold setting unit 14 continues to determine whether it is the acquisition start timing Tb for the output voltage until the acquisition start timing Tb for the output voltage comes (step S10). If it is the acquisition start timing Tb for the output voltage (step S10, Yes), the threshold setting unit 14 starts the acquisition of the output voltage (step S20).

The threshold setting unit 14 determines whether it is the acquisition end timing Tc for the output voltage (step S30). If it is not the acquisition end timing Tc for the output voltage (step S30, No), the threshold setting unit 14 continues to determine whether it is the acquisition end timing Tc for the output voltage until the acquisition end timing Tc for the output voltage comes (step S30).

If it is the acquisition end timing Tc for the output voltage (step S30, Yes), the threshold setting unit 14 ends the acquisition of the output voltage (step S40). Thus, the threshold setting unit 14 acquires the output voltage during an output voltage acquisition period P1 which is a period from the acquisition start timing Tb to the acquisition end timing Tc. The output voltage acquisition period P1 is a specific period after the piercing process is started, before the determination of whether the hole has penetrated the workpiece 9 is performed, and in which the hole has not penetrated the workpiece 9.

The threshold setting unit 14 calculates an average value which is a value obtained by averaging the output voltages acquired during the output voltage acquisition period P1 (step S50). In FIG. 7, the average value of the output voltages is illustrated as a measured value A1. The threshold setting unit 14 calculates a threshold B1 as a threshold for the output voltage on the basis of the measured value A1 which is the average value of the output voltages (step S60). The threshold setting unit 14 sets the calculated threshold B1 as a threshold used for the penetration determination (step S70). The measured value A1 may be a value obtained by time integration of the output voltages during the output voltage acquisition period P1 over the output voltage acquisition period P1.

The comparison unit 15 determines whether it is the penetration determination timing Td (step S80). If it is not the penetration determination timing Td (step S80, No), the comparison unit 15 continues to determine whether it is the penetration determination timing Td until the penetration determination timing Td comes (step S80).

The comparison unit 15 may set the penetration determination timing Td on the basis of the measured value A1. In that case, the comparison unit 15 sets, as the penetration determination timing Td, a time point when the output voltage decreases below the measured value A1 by the specific proportion or the specific value. The comparison unit 15 sets the penetration determination timing Td so that the output voltage at the penetration determination timing Td becomes a value larger than the threshold B1. For example, when the threshold B1 is a value which is 10% smaller than the measured value A1, the comparison unit 15 sets timing when the output voltage decreases below the measured value A1 by 5% as the penetration determination timing Td.

If it is the penetration determination timing Td (step S80, Yes), the comparison unit 15 starts the acquisition of the output voltage (step S90). Thus, a penetration determination period P2, which is a period in which the penetration determination is performed, starts. The penetration determination period P2 ends when it is determined that the hole has penetrated the workpiece 9 or when a specific time elapses. The comparison unit 15 compares the output voltage acquired after the penetration determination timing Td with the threshold B1, and determines whether the output voltage acquired after the penetration determination timing Td is equal to or lower than the threshold B1 (step S100).

If the acquired output voltage is not equal to or lower than the threshold B1 (step S100, No), the comparison unit 15 continues to determine whether the output voltage is equal to or lower than the threshold B1 until the output voltage becomes equal to or lower than the threshold B1 (step S100).

If the output voltage is equal to or lower than the threshold B1 and the set time has elapsed (step S100, Yes), the comparison unit 15 determines that it is the penetration timing Te when the hole penetrates the workpiece 9. The control unit 16 stops the irradiation of the irradiation position 3 with the laser beam 4 for the piercing process at a time point when it is determined that the hole has penetrated the workpiece 9 and ends the piercing process. Thereafter, the laser processing unit 20 performs the cutting process on the workpiece 9 by moving the processing head 5 while performing irradiation with the laser beam 4. When performing the next piercing process, the laser processing machine 100 newly performs the processes in steps S10 to S100. Note that FIG. 7 illustrates a case where the waveform 51 of the output voltage extends even after the penetration timing Te, but in reality, the irradiation with the laser beam 4 is stopped after the piercing process is ended.

The scattered light L1 detected by the optical sensor 8 is affected by an environment where the piercing process is performed, so that the output voltage from the optical sensor 8 is also affected by the environment where the piercing process is performed. The environment where the piercing process is performed includes a surface state of the workpiece 9, the plate thickness of the workpiece 9, a material of the workpiece 9, processing conditions when performing the piercing process on the workpiece 9, the type of piercing process, a maintenance state of the laser processing machine 100, an output state of the laser beam 4 by the laser oscillator 1, and the processing procedure of the piercing process. Examples of the processing conditions when performing the piercing process on the workpiece 9 include an intensity, a frequency, and a duty ratio of the laser beam 4 with which irradiation is performed. The type of piercing process includes a shape of a pierced hole, and the like. The processing procedure of the piercing process includes a change in the output of the laser beam 4 during the piercing process.

In addition, the scattered light L1 is scattered not only on the surface of the workpiece 9 but also on an inner wall surface of the nozzle 6 and an inner wall surface of the processing head 5. Therefore, the intensity of the scattered light L1 input to the optical sensor 8 changes depending on the shapes and surface states of the inner wall surface of the nozzle 6 and the inner wall surface of the processing head 5. Accordingly, the intensity of the scattered light L1 input to the optical sensor 8 is affected by contamination inside the nozzle 6, contamination of the processing head 5, and the like. The states of the inner wall surface of the nozzle 6 and the inner wall surface of the processing head 5 also change during laser processing, so the scattered light L1 detected by the optical sensor 8 continues to change as a laser processing environment changes. Therefore, if the penetration determination is performed in various environments using a fixed threshold, the determination as to whether the penetration has been achieved may be erroneous. In the present embodiment, since the threshold B1 is set using the output voltages acquired during the output voltage acquisition period P1, the threshold B1 can be set depending on the piercing process environment.

Since the threshold setting unit 14 continuously acquires the output voltage for setting the threshold B1 and performs the averaging process on the output voltages during the output voltage acquisition period P1, even if the output voltage from the optical sensor 8 contains noise, it is less likely to be affected by the noise. In addition, it is less likely to be affected by the noise also when the measured value A1 is a value obtained by time integration of the output voltages over the output voltage acquisition period P1. Therefore, the threshold setting unit 14 can set the threshold B1 for accurately determining the penetration timing Te.

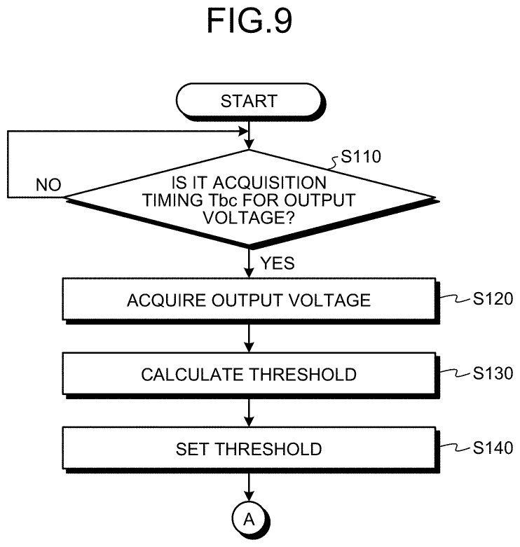

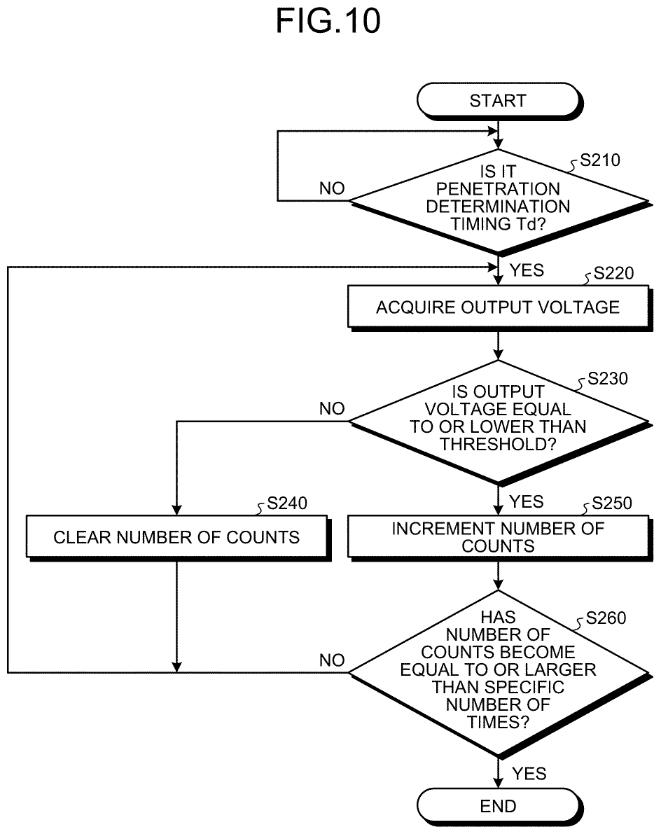

In order to reduce the amount of calculation, the threshold setting unit 14 may set the threshold on the basis of an instantaneous value of the output voltage acquired only at a specific timing, as in another example of the output voltage acquisition processing procedure described with reference to FIG. 9 below. The comparison unit 15 may determine that the penetration has been achieved when a period in which a value equal to or lower than the threshold is obtained continues for a certain period or longer, as in another example of a processing procedure of the penetration determination described with reference to FIG. 10 below.

FIG. 8 is a diagram for explaining another example of the penetration determination process performed by the laser processing machine according to the first embodiment. Similarly to FIG. 7, FIG. 8 illustrates the waveform 51 of the output voltage from the optical sensor 8, and the threshold is indicated by a threshold B2. In FIG. 8, the timing when the laser processing machine 100 starts the piercing process is indicated by the piercing start timing Ta, and timing when acquiring the output voltage for setting the threshold B2 is indicated by an acquisition timing Tbc. In addition, in FIG. 8, the penetration determination timing when starting the penetration determination is indicated by the penetration determination timing Td, and a period in which the output voltage is equal to or lower than the threshold B2 is indicated by a period P3.

First, processes performed when the threshold setting unit 14 sets the threshold B2 using only the output voltage acquired at the acquisition timing Tbc which is the specific timing will be described with reference to FIGS. 8 and 9. FIG. 9 is a flowchart illustrating another example of the output voltage acquisition processing procedure performed by the laser processing machine of the first embodiment. Each of processes in steps S110 to S140 illustrated in FIG. 9 is another example of the processes in steps S10 to S70 in FIG. 6.

At the piercing start timing Ta, the laser processing machine 100 starts the piercing process on the workpiece 9. The threshold setting unit 14 determines whether it is the acquisition timing Tbc for the output voltage (step S110). The acquisition timing Tbc for the output voltage is timing when acquiring the output voltage for setting the threshold B2, and is a specific timing in the output voltage acquisition period P1.

If it is not the acquisition timing Tbc for the output voltage (step S110, No), the threshold setting unit 14 continues to determine whether it is the acquisition timing Tbc for the output voltage until the acquisition timing Tbc for the output voltage comes (step S110).

If it is the acquisition timing Tbc for the output voltage (step S110, Yes), the threshold setting unit 14 acquires the output voltage (step S120). The threshold setting unit 14 calculates the threshold B2 of the output voltage on the basis of a measured value A2 which is the output voltage (step S130). The threshold setting unit 14 sets the calculated threshold B2 as the threshold B2 used for the penetration determination (step S140).

As described above, when the threshold B2 is calculated on the basis of the output voltage acquired at the acquisition timing Tbc, the output voltage acquisition process can be easily performed in a short period of time. In addition, since it is not necessary to calculate the average value of the output voltages, the amount of calculation can be reduced and the threshold B2 can be easily set.

In a case where the penetration determination is performed using the threshold B2 or the threshold B1, the comparison unit 15 may determine that the penetration has been achieved when a period in which the output voltage is equal to or lower than the threshold B2 or the threshold B1 continues for a certain period or longer. FIG. 10 is a flowchart illustrating another example of the processing procedure of the penetration determination performed by the laser processing machine of the first embodiment. Each of processes in steps S210 to S260 illustrated in FIG. 10 is another example of the processes in steps S80 to S100 in FIG. 6. Here, a case where the threshold B2 is set will be described.

After the threshold setting unit 14 sets the threshold B2, the comparison unit 15 determines whether it is the penetration determination timing Td (step S210). If it is not the penetration determination timing Td (step S210, No), the comparison unit 15 continues to determine whether it is the penetration determination timing Td until the penetration determination timing Td comes (step S210).

If it is the penetration determination timing Td (step S210, Yes), the comparison unit 15 acquires the output voltage (step S220). The comparison unit 15 compares the output voltage acquired after the penetration determination timing Td with the threshold B2, and determines whether the acquired output voltage is equal to or lower than the threshold B2 (step S230).

If the acquired output voltage is equal to or lower than the threshold B2 (step S230, Yes), the comparison unit 15 increments the number of counts indicating the number of times the output voltage is determined to be equal to or lower than the threshold B2 (step S250). Then, the comparison unit 15 determines whether the number of counts has become equal to or larger than a specific number of times (step S260). If the number of counts is smaller than the specific number of times (step S260, No), the comparison unit 15 returns to the process in step S220 and acquires the output voltage. The process in step S220 is performed periodically at regular intervals. That is, the output voltage is acquired at regular time intervals. The comparison unit 15 compares the acquired output voltage with the threshold B2, and determines whether the acquired output voltage is equal to or lower than the threshold B2 (step S230).

If the acquired output voltage is higher than the threshold B2 (step S230, No), the comparison unit 15 clears the number of counts (step S240). Then, the comparison unit 15 returns to the process in step S220 and acquires the output voltage.

The comparison unit 15 repeats the processes in steps S220 to S260 until it is determined in step S260 that the number of counts has become equal to or larger than the specific number of times. If the number of counts has become equal to or larger than the specific number of times (step S260, Yes), the comparison unit 15 determines that the hole has penetrated the workpiece 9 and ends the piercing process. The period from when the counting is started up to when the number of counts becomes the specific number of times is the period P3. As described above, the comparison unit 15 determines that the hole has penetrated the workpiece 9 when the number of counts becomes equal to or larger than the specific number of times, that is, when the period P3 elapses. This makes it possible for the comparison unit 15 to accurately determine the timing of penetration even if the output voltage from the optical sensor 8 varies due to noise or the like.

By the way, there is a method in which a piercing process is performed in a region where a product is not processed, and a detection level of scattered light is adjusted on the basis of scattered light generated during the piercing process. In this method, contamination of the nozzle 6 is caused by repeating product processing after the adjustment of the detection level of scattered light, so that there occurs a change in the amount of scattered light. Therefore, if the product processing is repeated, it becomes impossible to accurately detect the scattered light. In addition, when adjusting the detection level of scattered light during the product processing, the product processing has to be interrupted, which results in waste of time. On the other hand, the laser processing machine 100 sets, for each piercing process, the threshold B2 during the piercing process, so that it is not necessary to interrupt the product processing.

In addition, the laser processing machine 100 does not continue to use an identical value as a threshold used during the piercing process, but determines the threshold B1 on time during an actual piercing process, so that there is no difference occurring between the threshold which has been set prior to deterioration over time, and the threshold B1 to be actually set. That is, the laser processing machine 100 can set an appropriate threshold B1 during the actual piercing process.

As described above, in the first embodiment, the threshold B1 which serves as a criterion for determining whether the hole has penetrated the workpiece 9 by the piercing process is set on the basis of the output voltage output during a certain period after the piercing process is started, and it is determined whether the hole has penetrated the workpiece 9 on the basis of the output voltage thereafter and the set threshold B1. This makes it possible to set an appropriate threshold B1 depending on the piercing process regardless of the environment in which the piercing process is performed, so that the detection accuracy of whether the hole has penetrated the workpiece 9 is improved. Accordingly, it is possible to accurately determine whether a hole has penetrated the workpiece 9 in various processing environments.

### Second Embodiment

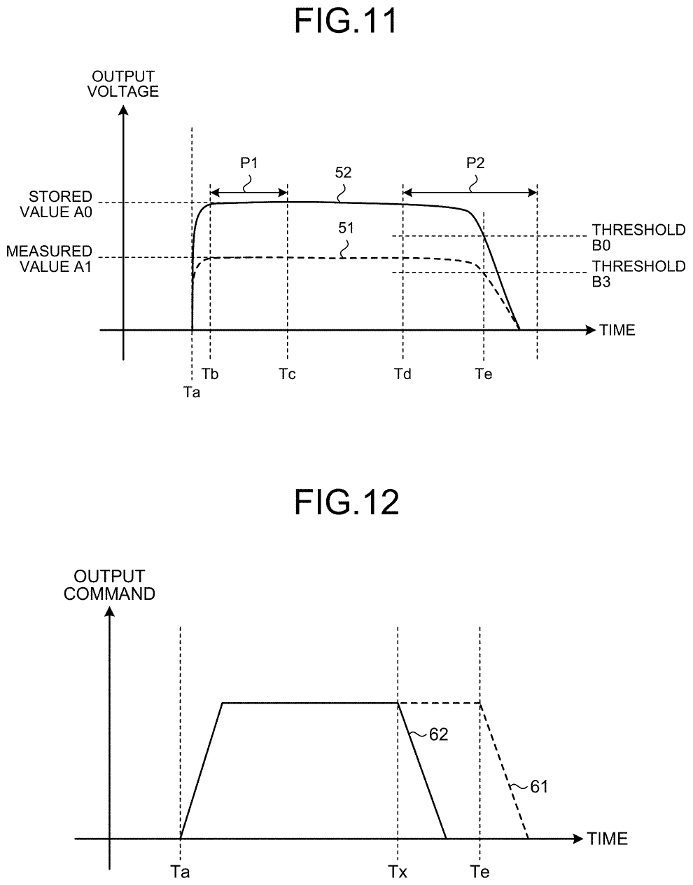

Next, a second embodiment of the invention will be described with reference to FIGS. 11 and 12. Also in the second embodiment, the laser processing machine 100 performs a piercing process in a processing procedure similar to that in the piercing process described with reference to FIG. 6 in the first embodiment. A method of calculating a threshold by the laser processing machine 100 in the second embodiment is different from that in the first embodiment. Specifically, in the second embodiment, the laser processing machine 100 sets a threshold on the basis of a reference output voltage, a threshold corresponding to the reference output voltage, and output voltages acquired during the output voltage acquisition period P1.

FIG. 11 is a diagram for explaining a penetration determination process performed by the laser processing machine according to the second embodiment. Of the timings illustrated in FIG. 11, the same timings as those illustrated in FIG. 7 are given the same reference characters as those in FIG. 7. In FIG. 11, a waveform of the output voltage during a first piercing process is indicated by the waveform 51, and a waveform of the output voltage during a second piercing process is indicated by a waveform 52. The first piercing process is the piercing process described in the first embodiment, and the second piercing process is a piercing process for measuring the reference output voltage. The second piercing process is performed before the first piercing process, and is not performed for each piercing process. The second piercing process is performed, for example, under a processing environment in an ideal state. An example of the ideal state is a state in which there is no contamination of the processing head 5 and the nozzle 6.

The reference output voltage may be one measured by the optical sensor 8 of the laser processing machine 100, or may be one measured by another laser processing machine. In a case of using, as the reference output voltage, one measured by the optical sensor 8 of the laser processing machine 100, the reference output voltage can be easily acquired. A threshold B0 corresponding to the reference output voltage may be one calculated by the laser processing machine 100 or may be one calculated by another laser processing machine.

A reference output voltage measured when the second piercing process is performed and the threshold B0 which serves as a criterion for determining whether a hole has penetrated the workpiece 9 when the second piercing process is performed at the reference output voltage are stored in the storage unit 12 of the control apparatus 10. The threshold B0 is a determination criterion value which serves as a criterion for determining whether a hole has penetrated the workpiece 9 when the piercing process is performed under the condition that the reference output voltage is output from the optical sensor 8. In FIG. 11, an average value of the output voltages measured and stored during the output voltage acquisition period P1 in the second piercing process is illustrated as a stored value A0, and an average value of the output voltages measured during the output voltage acquisition period P1 in the first piercing process is illustrated as the measured value A1.

In the second embodiment, the threshold setting unit 14 calculates a threshold B3 corresponding to the measured value A1 on the basis of the stored value A0 and the threshold B0 which have been set in advance, and the measured value A1 acquired in the first piercing process.

The threshold setting unit 14 calculates the threshold B3 using the following formula (1).

Threshold B3=threshold B0×(measured value A1/stored value A0) (1)

As described above, the threshold setting unit 14 calculates the threshold B3 which makes the ratio of the stored value A0 in the second piercing process to the threshold B0 as a criterion and the ratio of the measured value A1 in the first piercing process to the threshold B3 equal to each other. This makes it possible to set an appropriate threshold B3 depending on the ratio of the stored value A0 to the threshold B0 as a criterion on the basis of the measured value A1.

The threshold setting unit 14 sets the calculated threshold B3 as a threshold used for the penetration determination. Thus, the threshold B0 set in the second piercing process is changed to the threshold B3 depending on the measured value A1.

Thereafter, the comparison unit 15 determines whether it is the penetration determination timing Td during the first piercing process. If it is the penetration determination timing Td, the comparison unit 15 starts the acquisition of the output voltage. The comparison unit 15 compares the acquired output voltage with the threshold B3 and determines whether the acquired output voltage is equal to or lower than the threshold B3. If the output voltage is equal to or lower than the threshold B3, the comparison unit 15 determines that it is the penetration timing Te when the hole penetrates the workpiece 9 and ends the first piercing process.

The period in which the measured value A1 is acquired and the period in which the stored value A0 is acquired may be different from each other. That is, the output voltage acquisition period P1 in which the output voltage used to calculate the measured value A1 is acquired and the output voltage acquisition period P1 in which the output voltage used to calculate the stored value A0 is acquired may be periods different from each other. In other words, the time when the stored value A0 is acquired and the time when the measured value A1 is acquired may be the same as or different from each other.

The measured value A1 may be the output voltage acquired at the acquisition timing Tbc, and the stored value A0 may be the output voltage acquired at the acquisition timing Tbc. In that case, the acquisition timing Tbc when the measured value A1 is acquired and the acquisition timing Tbc when the stored value A0 is acquired may be timings different from each other.

The laser processing machine 100 performs the second piercing process for measuring the reference output voltage to obtain the stored value A0 and the threshold B0, but the second piercing process may be a piercing process immediately before the first piercing process. That is, the laser processing machine 100 may perform control by using the measured value A1 and the threshold B3 obtained by the piercing process immediately before the first piercing process as a new stored value A0 and a new threshold B0 of the first piercing process to be determined.

The threshold setting unit 14 determines that the piercing process is abnormal when the ratio of the stored value A0 to the measured value A1 falls outside a specific range. Specifically, the threshold setting unit 14 sets an upper limit value and a lower limit value for the measured value A1/stored value A0. In a case where the measured value A1/stored value A0 has dropped below the lower limit value, the reliability of the penetration determination may possibly decrease, so that the threshold setting unit 14 causes the alarm output device 35 to output an alarm. In addition, in a case where the measured value A1/stored value A0 has exceeded the upper limit value, the optical sensor 8 may possibly have failed, so that the threshold setting unit 14 causes the alarm output device 35 to output an alarm. This makes it possible to notify a user of the laser processing machine 100 of an abnormality in the piercing process.

FIG. 12 is a diagram for explaining timing of penetration determined by a penetration determination method of the second embodiment. The horizontal axis in FIG. 12 is time, and the vertical axis therein is output command of the laser beam 4. FIG. 12 illustrates a waveform 61 of an output command of the laser beam 4 when the penetration determination is performed on the basis of the threshold B3, and a waveform 62 of an output command of the laser beam 4 when the penetration determination is performed on the basis of the threshold B0.

In the first embodiment, the threshold B1 is obtained for each piercing process, but in the second embodiment, the threshold B3 is determined for each piercing process using the threshold B0 obtained in the ideal state. If the threshold B0 obtained in the ideal state is used as it is in the second embodiment, it is determined that penetration has been achieved only because the measured value A1 is lower than the threshold B0, which prevents accurate penetration determination from being performed. That is, when the penetration determination is performed on the basis of the threshold B0, the penetration determination is performed using the threshold B0 in a normal state, even though the measured value A1 is lower than that in the normal state due to contamination of the nozzle 6 and the like. Therefore, it is determined that the penetration has been achieved at timing earlier than the accurate penetration timing Te. In the case of the penetration determination on the basis of the threshold B3 which is the penetration determination method of the second embodiment, the penetration determination can be performed on the basis of an appropriate threshold B3 depending on the first piercing process, so that the penetration timing Te can be accurately determined similarly to the first embodiment.

As described above, in the second embodiment, the threshold B3 corresponding to the measured value A1 is set on the basis of the stored value A0 which is the output voltage during the second piercing process, the threshold B0 corresponding to the stored value A0, and the measured value A1 during the first piercing process. Then, on the basis of the threshold B3 and the output voltage after the penetration determination timing Td, it is determined whether the hole has penetrated the workpiece 9. This makes it possible to perform the penetration determination on the basis of an appropriate threshold B3 depending on the first piercing process and the second piercing process, so that the detection accuracy of whether the hole has penetrated the workpiece 9 is improved. Accordingly, similarly to the first embodiment, it is possible to accurately determine whether a hole has penetrated the workpiece 9 in various processing environments.

Here, a hardware configuration of the control apparatus 10 described in the first and second embodiments will be described. The control apparatus 10 can be realized by a control circuit, that is, a processor and a memory. The processor and the memory may be replaced with a processing circuitry. A part of functions of the control apparatus 10 may be realized by dedicated hardware and another part thereof may be realized by software or firmware.

The configurations described in the embodiments above are merely examples of the content of the present invention and can be combined with other known technology and part thereof can be omitted or modified without departing from the gist of the present invention.

### REFERENCE SIGNS LIST

1 laser oscillator; 3 irradiation position; 4 laser beam; 5 processing head; 6 nozzle; 7 processing table; 8 optical sensor; 9 workpiece; 10 control apparatus; 11 input unit; 12 storage unit; 13 penetration determination unit; 14 threshold setting unit; 15 comparison unit; 16 control unit; 20 laser processing unit; 35 alarm output device; 100 laser processing machine; P1 output voltage acquisition period; P2 penetration determination period; P3 period; Ta piercing start timing; Tb acquisition start timing; Tbc acquisition timing; Tc acquisition end timing; Td penetration determination timing; Te penetration timing.

1. A laser processing machine comprising:
a laser oscillator to emit a laser beam;
a processing head to laser process an object to be worked by performing irradiation with the laser beam;
a processing machine controller to control the laser oscillator and the processing head;
a light sensor circuitry to measure scattered light from the object to be worked, the scattered light being generated when the object to be worked is irradiated with the laser beam, and to output a signal corresponding to the scattered light;
a threshold setting circuitry to, on a basis of the signal output during a certain period after a piercing process is started, set a threshold serving as a criterion for determining whether a hole has penetrated the object to be worked by the piercing process; and
a penetration determination circuitry to determine whether a hole has penetrated the object to be worked on a basis of the signal and the threshold, wherein
the threshold setting circuitry sets the threshold on a basis of a reference signal set in advance, a determination criterion value serving as a criterion for determining whether a hole has penetrated the object to be worked when performing a piercing process under a condition that the reference signal is output from the light sensor circuitry, and the signal.

2. The laser processing machine according to claim 1, wherein
the threshold setting circuitry calculates a measured value that is a value obtained by performing an averaging process on signals output a plurality of times during the certain period or a value obtained by time integration of signals output a plurality of times during the certain period over the certain period, and sets the threshold on a basis of the measured value.

3. The laser processing machine according to claim 1, wherein
the threshold setting circuitry sets the threshold on a basis of a signal output at a specific timing in the certain period.

4. The laser processing machine according to claim 1, wherein
the penetration determination circuitry determines that a hole has penetrated the object to be worked when a period in which the signal is equal to or lower than the threshold continues for a certain period or longer.

5. (canceled)

6. The laser processing machine according to claim 1, wherein
the reference signal is output from the light sensor circuitry during a piercing process performed before the piercing process for determining the threshold.

7. The laser processing machine according to claim 1, wherein
the threshold setting circuitry sets the threshold so that a ratio of the reference signal to the determination criterion value and a ratio of the signal to the threshold are equal to each other.

8. The laser processing machine according to claim 1, further comprising an alarm output circuitry to output an alarm, wherein
the threshold setting circuitry determines an abnormality in the piercing process on a basis of the reference signal and the signal, and if there is an abnormality, the threshold setting circuitry causes the alarm output circuitry to output an alarm.

9. The laser processing machine according to claim 8, wherein
the threshold setting circuitry determines that the piercing process is abnormal when a ratio of the reference signal to the signal falls outside a certain range.

10. A control apparatus that controls a processing head that laser processes an object to be worked by performing irradiation with a laser beam, the apparatus comprising:
an input circuitry to receive a signal corresponding to scattered light from the object to be worked, the scattered light being generated when the object to be worked is irradiated with the laser beam;
a threshold setting circuitry to, on a basis of the signal output during a certain period after a piercing process is started, set a threshold serving as a criterion for determining whether a hole has penetrated the object to be worked by the piercing process; and
a penetration determination circuitry to determine whether a hole has penetrated the object to be worked on a basis of the signal and the threshold, wherein
the threshold setting circuitry sets the threshold on a basis of a reference signal set in advance, a determination criterion value serving as a criterion for determining whether a hole has penetrated the object to be worked when performing a piercing process under a condition that the reference signal is output from the light measurement circuitry, and the signal.

11. A determination method comprising:
receiving a signal corresponding to scattered light from an object to be worked, the scattered light being generated when the object to be worked is irradiated with a laser beam;
on a basis of the signal output during a certain period after a piercing process is started, setting a threshold that serves as a criterion for determining whether a hole has penetrated the object to be worked by the piercing process; and
determining whether a hole has penetrated the object to be worked on a basis of the signal and the threshold, wherein
the threshold is set on a basis of a reference signal set in advance, a determination criterion value serving as a criterion for determining whether a hole has penetrated the object to be worked when performing a piercing process under a condition that the reference signal is output from the light sensor circuitry, and the signal.
